(19) United States
(12) Patent Application Publication
(10) Pub. No.: US 2014/0061105 A1
(43) Pub. Date: Mar. 6, 2014

(54) Popcorn pal

(71) Applicant: Kenneth T. Goodson, JR., Green Mountain, NC (US)

(72) Inventor: Kenneth T. Goodson, JR., Green Mountain, NC (US)

(21) Appl. No.: 13/506,614

(22) Filed: Aug. 31, 2012

(51) Int. Cl. B07B 1/00

(52) U.S. Cl. 209/675

(57) ABSTRACT

The Popcorn Pal is a round molded plastic disk formed like a grate, to be used to separate popcorn kernels from cooked popcorn. Item is to be placed in the bottom of a bowl (standard size from 9 inch or larger) popped corn is placed in the bowl and kernels fall to the bottom of the bowl through the plastic grate, separating them from the popped corn.

The item is constructed from injection molded plastic, that is smooth to the touch and resistant to bending or warping. The item is also microwave and dishwasher safe.

The overall height is 19 mm

The overall circumference is 176 mm

The outside diameter is 161 mm

The inside diameter is 153 mm

The item has 3 legs −15 mm in height

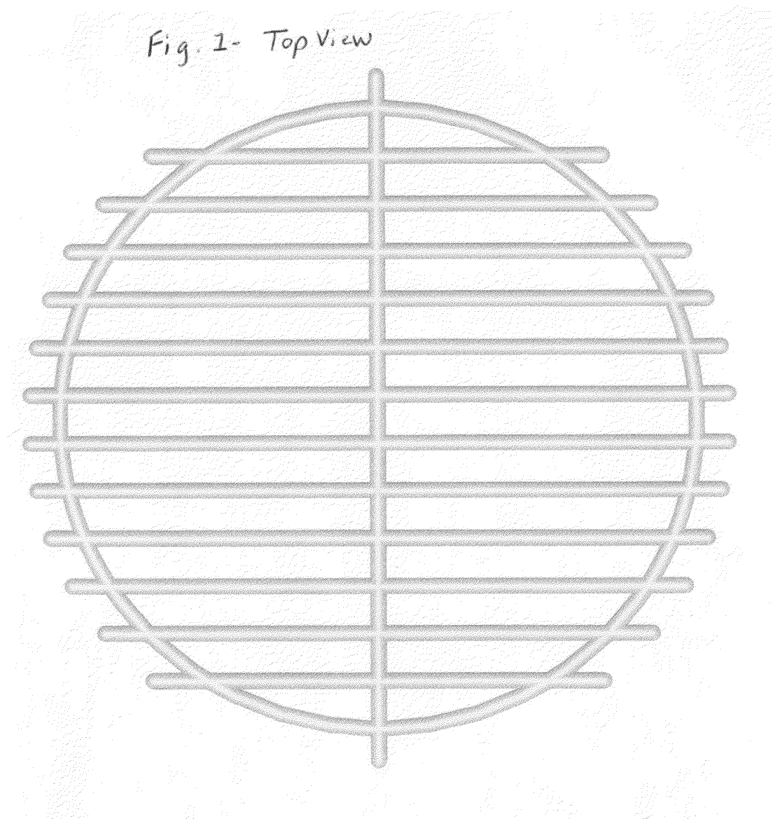

FIG. 1 is a top view of the Popcorn Pal showing my new design

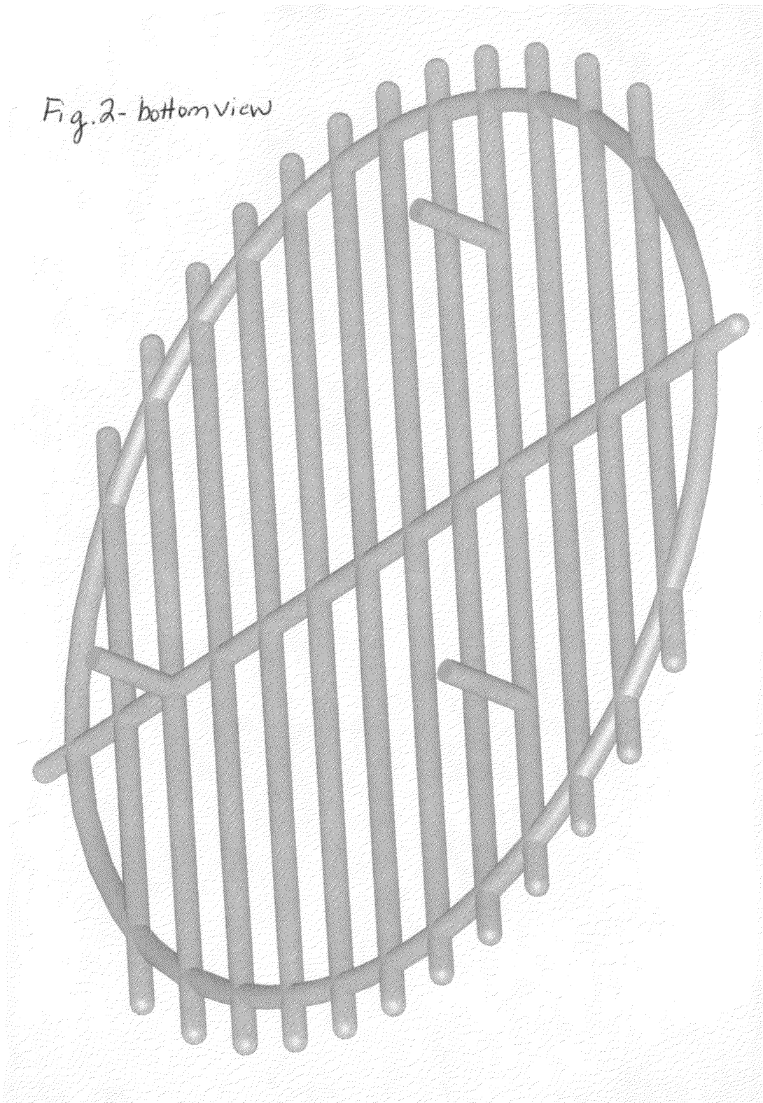

FIG. 2 is a bottom view thereof

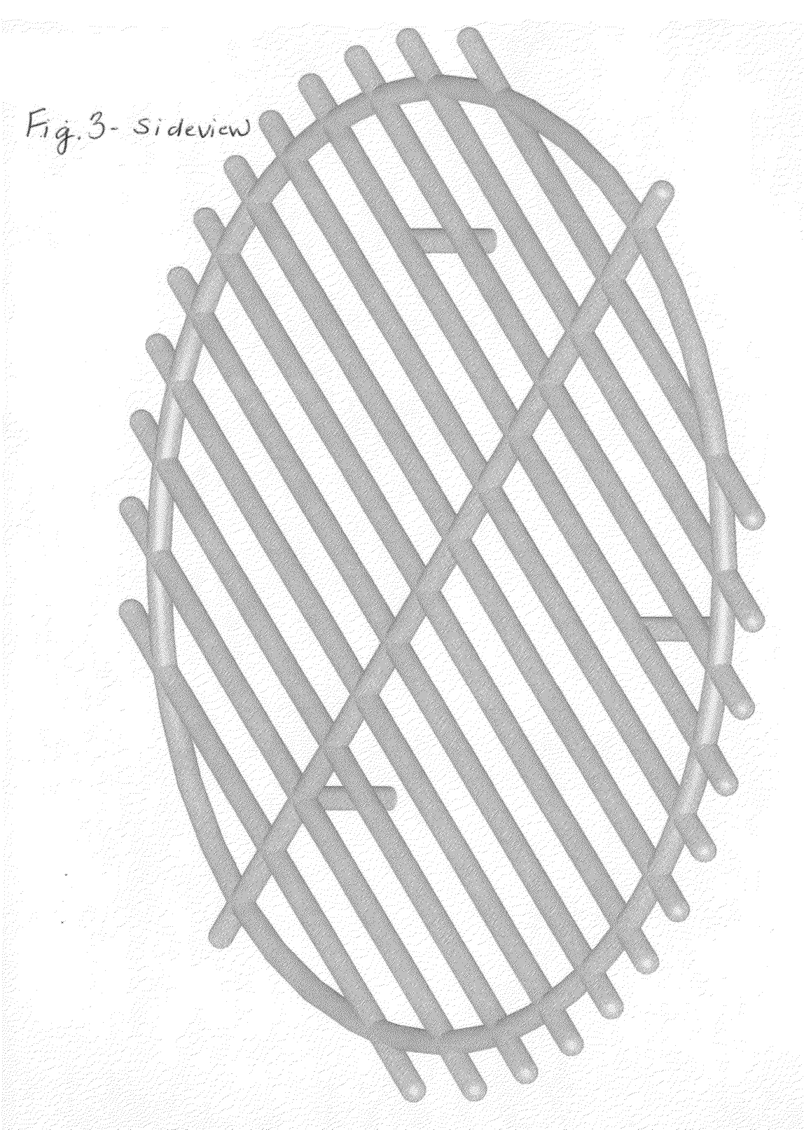

FIG. 3 is a side view thereof

I claim the utility design for a Popcorn Pal as shown

1. A molded plastic item for use with kitchen bowls to separate popcorn kernels from popcorn
